(19) United States
(12) Patent Application Publication
(10) Pub. No.: US 2021/0342688 A1
(43) Pub. Date: Nov. 4, 2021

(54) NEURAL NETWORK TRAINING METHOD, DEVICE AND STORAGE MEDIUM BASED ON MEMORY SCORE

(71) Applicant: UnitX, Inc., San Jose, CA (US)

(72) Inventor: Kedao Wang, San Jose, CA (US)

(73) Assignee: UnitX, Inc., San Jose, CA (US)

(21) Appl. No.: 17/226,596

(22) Filed: Apr. 9, 2021

(30) Foreign Application Priority Data
Apr. 30, 2020 (CN) 202010362623.9

(51) Int. Cl. G06N 3/08; G06K 9/62; G06T 7/00

(52) U.S. Cl. CPC G06N 3/08; G06T 7/0004; G06K 9/623; G06K 9/6256

(57) ABSTRACT

The present disclosure relates to a method, devices, and storage medium for training neural networks based on memory scores. The said method comprises: establishing the memory scores of a plurality of first-sample images in the library, from their training ages and training indicators, and a preset discount rate; determining a plurality of second-sample images from these memory scores and a preset first count, and using them to establish the first training set; training the neural network by using the first training set, with the said neural network is used for defect detection. The neural network training method in the disclosed embodiment reduces the size of the training set and shortens the time to converge, thereby improving training efficiency.

### CROSS-REFERENCE TO RELATED APPLICATIONS

This application claims priority to Chinese Patent Application No. 202010362623.9, filed on Apr. 30, 2020. The disclosure of the above application is hereby incorporated by reference in its entirety.

### FIELD

The present disclosure relates to the field of computer technology, and in particular to a neural network training method, device, and storage medium based on memory scores.

### BACKGROUND

As deep learning develops, neural networks have seen numerous applications in detecting defects. Those networks that perform detection on production lines witness new defects being continuously generated. Defects may appear in the first month as scratches but as cracks in the second month. The continuing generation of new defects means that the training set keeps expanding, requiring ever-increasing time to train the neural network, hence making rapid iteration difficult.

Moreover, defect labelers usually have delays in recognizing new defects. It is possible that after a labeler labeled 1000 sample images and passed them through the neural network, he or she then realized that some labels were problematic. This finding would require the labeler to return to the labels and spend much time in rectifying the problematic ones. Besides, the training set may contain many redundant samples, and therefore may become unnecessarily large and difficult to organize.

### SUMMARY

In view of this, the present disclosure proposes a technical solution for training neural network based on memory scores.

According to one aspect of the present disclosure, there is provided a neural network training method based on memory scores, which comprises: determining the memory scores of a plurality of first-sample images from the library based on the training ages and training indicators of these first-sample images and a preset discount rate, wherein the said first-sample images are images of the object to be inspected, the said first-sample images include at least one newly-added image, the training indicators represent whether the first-sample images are added to the training set of each training session of the neural network, the training ages indicate the number of times the neural network is trained after the first-sample images are added to the library, and the said memory scores indicate the degree of involvement of the first-sample images in training; determining a plurality of second-sample images from the said library, according to the memory scores of the said first-sample images and the preset first count, and using these images to establish a first training set; training the neural network by using the said first training set, wherein the said neural network is used for defect detection.

In an embodiment, the method further comprises: determining a plurality of third-sample images from the library according to the memory scores and training ages of the said first-sample images and the preset second count, and using these images to establish a second training set; using the second training set to train the neural network.

In another embodiment, the memory scores of the plurality of first-sample images are determined according to the training ages and training indicators of the library's said first-sample images and the preset discount rate, comprising: for any first-sample image, determining its discounted score when the neural network undergoes the i^{th} training, based on the preset discount rate and the training indicator of the said first-sample image in the i^{th} training, where i is defined as the number of training sessions before the current one, with the i of the current training is set to 0, i is an integer and ≤N, N is the training age of the said first-sample image, an integer and N≥0; the sum of the N discounted scores of the said first-sample image is determined as the memory score of the said first-sample image.

In another embodiment, when the said first-sample images are added to the training set during the i^{th} training of the neural network, the training indicators of the said first-sample images in the i^{th} training are set to 1, when the said first-sample image is not added to the training set during the i^{th} training of the neural network, the training indicator of the said first-sample image in the i^{th} training is set to 0.

In another embodiment, the discounted score of the said first-sample image in the i^{th} training of the neural network is determined based on the training indicator of the image during the i^{th} training and the preset discount rate, comprising: setting the discounted score of the said first-sample image during the i^{th} training of the neural network, as the product of the training indicator during the i^{th} training and the preset discount rate raised to the i^{th} power.

In another embodiment, a plurality of second-sample images are determined from the said library to establish a first training set, based on the memory scores of the said first-sample images and the preset first count, comprising: determining the second-sample images, which are the first-sample images with the lowest memory scores, from the said library, according to the memory scores of the said first-sample images and the preset first count; establishing the first training set based on the said second-sample images.

In another embodiment. the second training set is established by determining a plurality of third-sample images from the said library, based on the memory scores and training ages of the said first-sample images and the preset second count, comprising: determining the fourth-sample images from the library by selecting the first-sample images with the lowest memory scores; determining fifth-sample images from the library by selecting the first-sample images with the smallest training ages, wherein the sum of the number of fourth-sample images and fifth-sample images equals to the preset second count; setting the third-sample images as the union of the said fourth-sample images and fifth-sample images; establishing the second training set based on the said third-sample images.

In another embodiment, before determining the memory scores of the plurality of first-sample images, the said method further comprises: loading the labeled images into the neural network for defect detection to obtain the detection result of the said images, where the said labeled images are newly-added images that have not been added to the library; when the detection result of the labeled image is inconsistent with the preset expected result, modifying the label to obtain a modified label of the said image; adding the labeled images and the modified labels of the said images to the library.

In an embodiment, the method further comprises: when the detection result of the labeled image is consistent with the expected result, discard the said labeled image.

According to another aspect of the present disclosure, there is provided a neural network training device based on memory scores, with the said device comprising: a memory score determination component, which determines the memory scores of a plurality of first-sample images from the library based on a preset discount rate and the training ages and training indicators of these first-sample images, wherein the said first-sample images are images of the object to be inspected, the said first-sample images include at least one newly-added image, the training indicators represent whether the first-sample images are added to the training set of each training session of the neural network, the training ages indicate the number of times the neural network is trained after the first-sample images are added to the library, and the said memory scores indicate the degree of involvement of the first-sample images in training; a first training set establishment component, which determines a plurality of second-sample images from the said library, according to the memory scores of the said first-sample images and the preset first count, and uses these images to establish a first training set; a first training component, which trains the neural network based on the said first training set, wherein the said neural network is used for defect detection.

In another embodiment, the device further includes: a second training set establishment component, which determines a plurality of third-sample images from the said library according to the memory scores and training ages of the first-sample images and the preset second count, and uses these images to establish a second training set; a second training component, which trains the neural network based on the said second training set.

In an embodiment, the memory score determination component comprises: a discounted score determination sub-component, which determines the discounted score of any first-sample image when the neural network undergoes the i^{th} training, based on the training indicator of the said first-sample image in the i^{th} training and the preset discount rate, where i is defined as the number of training sessions before the current one, with the i of the current training of the neural network is set to 0, i is an integer and with N being the training age of the said first-sample image, an integer and N≥0; a memory score determination sub-component, which sets the sum of the N discounted scores of the first-sample image as the memory score of the said first-sample image.

In another embodiment, when the said first-sample images are added to the training set during the i^{th} training of the neural network, the training indicators of the said first-sample images in the i^{th} training are set to 1, when the said first-sample image is not added to the training set during the i^{th} training of the neural network, the training indicator of the said first-sample image in the i^{th} training is set to 0.

In another embodiment, the discounted score determination sub-component is configured as: setting the discounted score of the said first-sample image during the i^{th} training of the neural network, as the product of the training indicator during the i^{th} training and the preset discount rate raised to the i^{th} power.

In an embodiment, the said first training set establishment component comprises: a first-sample images determination sub-component, which determines a plurality of second-sample images with the lowest memory scores from the said library, according to the memory scores of the said first-sample images and the preset first count; a first training set establishment sub-component, which establishes the first training set based on the said second-sample images.

In another embodiment, the said second training set establishment component comprises: a second-sample images determination sub-component, which determines the plurality of fourth-sample images by selecting the first-sample images with the lowest memory scores in the said library; a third-sample images determination sub-component, which determines fifth-sample images from the library by selecting the first-sample images with the smallest training ages, wherein the sum of the number of fourth-sample images and fifth-sample images equals to the preset second count; a fourth-sample images determination sub-component, which determines the set of third-sample images as the total of the said fourth-sample images and fifth-sample images; a second training set establishment sub-component, which establishes the second training set based on the said third-sample images.

In another embodiment, the device further includes: an image detection component, which loads the labeled images into the neural network for defect detection to obtain the detection result of the said images, where the said labeled images are newly-added images that have not been added to the library; an image labeling component, which is used to modifying the label to obtain a modified label of the said image, when the detection result of the labeled image is inconsistent with the preset expected result; an image adding component, which is used to add the labeled images and the modified labels of the said images to the library.

In another embodiment, the device further includes: an image discarding component, which discards the said labeled image when the detection result of the labeled image is consistent with the expected result.

According to another aspect of the present disclosure, there is provided a computer-readable storage medium with computer programs and instructions stored thereon, characterized in that when the computer program is executed by a processor, it implements the above-stated methods.

According to an embodiment of the present disclosure, when the library includes the newly added first-sample images, the method determines the memory scores of these images based on the training ages and training indicators of a plurality of first-sample images and the preset discount rate, then selects the second-sample images and establishes a first training set, based on the memory scores of the first-sample images and the preset first count, and trains the neural network using the first training set. Therefore, when new sample images are added to the library, it can pick a certain number of sample images from the library and establish a training set, according to the memory score of each sample image, so that the training set includes the newly added images and existing images. Training the neural network using this training set allows the neural network to retain memories of the old defects as it learns the characteristics of new defects, and using the training set shortens the time to converge in training, therefore making the neural network faster in learning new defects.

### BRIEF DESCRIPTION OF THE DRAWINGS

The following gives detailed description of the specific embodiments of the present invention, accompanied by diagrams to clarify the technical solutions of the present invention and its benefits.

FIG. 1 shows a flowchart of a neural network training method based on memory scores, according to an embodiment of the present disclosure.

FIG. 2 shows a flowchart of a neural network training method based on memory scores, according to an embodiment of the present disclosure.

FIG. 3 shows a schematic diagram of an application scenario of a neural network training method based on memory scores, according to an embodiment of the present disclosure.

FIG. 4 shows a schematic diagram of an application scenario of a neural network training method based on memory scores, according to an embodiment of the present disclosure.

FIG. 5 shows a block diagram of a neural network training device based on memory scores, according to an embodiment of the present disclosure.

FIG. 6 shows a block diagram of a neural network training device based on memory scores, according to an embodiment of the present disclosure.

### DETAILED DESCRIPTION

The technical solutions in the embodiments of the present invention will be clearly and completely described below, accompanied by diagrams of embodiments. Obviously, the described embodiments are only a part of the embodiments of the present invention, rather than all possible embodiments. Based on the embodiments of the present invention, all other embodiments obtained by those skilled in the art without creative work shall fall within the protection of the present invention.

The neural network training method based on memory scores, described in the embodiments of the present disclosure, can be applied to a processor. The said processor may be a general purpose processor, such as a CPU (Central Processing Unit), or an artificial intelligence processor (IPU), for example, one of or a combination of the following: GPU (Graphics Processing Unit), NPU (Neural-Network Processing Unit), DSP (Digital Signal Process), FPGA (Field Programmable Gate Array), or ASIC (Application Specific Integrated Circuit). The present disclosure does not limit the types of processors.

The said neural network described in the embodiment of the present disclosure could be used for defect detection. For example, the neural network can be used in a defect detection equipment or system installed on production lines. Images of the object to be inspected may be loaded to the neural network to determine whether the object has defects. The object to be inspected can be various types of parts and castings produced by the production line. The present disclosure does not limit the specific types of objects to be inspected.

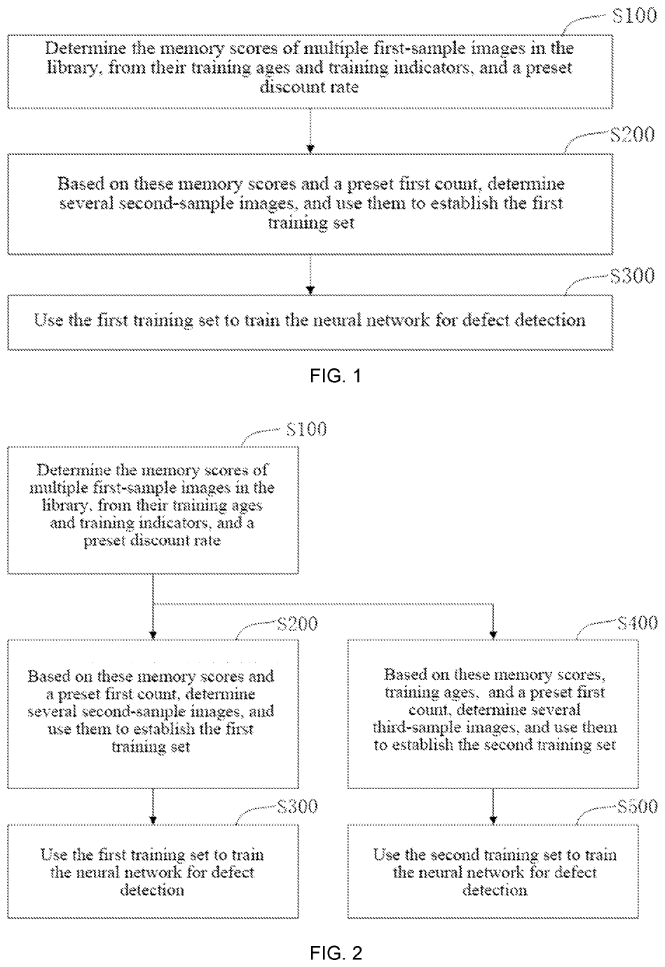

FIG. 1 shows a flowchart of a neural network training method based on memory scores, according to an embodiment of the present disclosure. As shown in FIG. 1, the said method comprises: Step S100: determines the memory scores of a plurality of first-sample images from the library based on the training ages and training labels of these first-sample images and a preset discount rate, wherein the said first-sample images are images of the object to be inspected, the said first-sample images include at least one newly-added image, the training labels represent whether the first-sample images are added to the training set of each training round of the neural network, the training ages indicate the number of times the neural network is trained after the first-sample images are added to the library, and said the memory score indicates the degree of involvement in training of the first-sample images in training; Step S200: determines a plurality of second-sample images from the said library, according to the memory scores of the said first-sample images and the preset first count, and uses these images to establish a first training set; Step S300: trains the neural network based on the said first training set.

According to an embodiment of the present disclosure, when the library includes the newly added first-sample images, the method determines the memory scores of these images based on the training ages and training indicators of a plurality of first-sample images and the preset discount rate, then selects the second-sample images and establishes a first training set, based on the memory scores of the first-sample images and the preset first count, and trains the neural network using the first training set. Therefore, when new sample images are added to the library, it can pick a certain number of sample images from the library and establish a training set, according to the memory score of each sample image, so that the training set includes the newly added images and existing images. Training the neural network using this training set allows the neural network to retain memories of the old defects as it learns the characteristics of new defects, and using the training set shortens the time to converge in training, therefore making the neural network faster in learning new defects.

In another embodiment, the training of the neural network may include advanced training. Advanced training means that when the library includes newly added first-sample images, the neural network training will use both the existing and the newly added first-sample images, so that the neural network can detect defects from both the existing and the newly added first-sample images.

In another embodiment, the first-sample images may be images of the object to be inspected. The object to be inspected can be specified according to the application scenarios of the neural network. For example, when a neural network is used for defect detection of parts produced on a production line, the objects to be inspected are the parts, and the first-sample images are images of the parts. The present disclosure does not limit the specific objects.

In another embodiment, the said library may include a plurality of first-sample images, and the first-sample images include at least one newly added image. This means that the first-sample images in the library are of two types, one being the images newly added during this training, and the other being images that have been existing before this training. Among which, the newly added first-sample images may be sample images of a new defect.

In another embodiment, the training ages of the first-sample image may be used to indicate the number of times the neural network is trained after the first-sample image is added to the library. For example, after a first-sample image is added to the library, the neural network is trained five times, then the training age of the first-sample images is 5. Having a smaller training age means that the first-sample image is more recently added to the library.

In another embodiment, the training indicator of the first-sample image can be used to indicate after these images are added to the library, whether the first-sample image is added to each round of the neural network's training set. This means that after a first-sample image is added to the library, the first-sample image will have a training indicator corresponding to each round of training of the neural network. The value of the training indicator is either 0 or 1. 0 indicates that the first-sample image is not added to the neural network's corresponding training session, and 1 indicates that the first-sample image is added to the neural network's corresponding training session.

In another embodiment, Step S100 can determine the memory scores of the first-sample images, according to the training ages and training indicators of the library's said first-sample images and the preset discount rate, wherein the preset discount rate is used to represent the neural network's propensity to remember. The smaller the discount rate, the lower the neural network's propensity to remember, and the easier it is for the neural network to forget the previously learned features. The range of the discount rate is greater than 0 and less than 1, for example, the discount rate can be set to 0.8. Those skilled in the art can set the specific value of the discount rate according to actual needs, and the present disclosure does not limit the choices.

In another embodiment, the memory score of the first-sample images may be used to represent the degree of involvement in training of these first-sample images, A higher memory score of the first-sample images means a higher degree of involvement in training.

In another embodiment, when the newly added first-sample image has not participated in the training of the neural network, the memory score of the newly added first-sample image will be set to 0.

In another embodiment, after the memory scores of a plurality of first-sample images are determined, Step S200 determines second-sample images from the said library to establish a first training set, based on the memory scores of the said first-sample images and the preset first count. Wherein the number of the second-sample images equals to the preset first count. The preset first count can be set according to the actual need, and the present disclosure does not limit this.

In another embodiment, when choosing a plurality of second-sample images from the said library to establish a first training set, based on the memory scores of the said first-sample images and the preset first count, there may be multiple methods. For example, the chosen second-sample images may be first-sample images with memory scores within a certain interval (for example, less than 1) from the library, and the total number of such images equals to the preset first count; or, the possible memory scores may be divided into a number of intervals, and the first-sample images in the library are divided into groups based on these intervals, and use sampling methods to pick second-sample images from these groups, with the total number of second-sample images equals to the preset first count; or, the second-sample images can be chosen as the first-sample images with the lowest memory scores, and the total number of second-sample images equals to the preset first count; or other means can be used. The present disclosure does not limit the specific method of selecting the second-sample images based on memory scores.

In another embodiment, after a plurality of second-sample images is selected, the first training set can be established based on these second-sample images and their labels.

In another embodiment, after the first training set is established, Step S300 can train the neural network using the first training set. A plurality of sample images in the first training set can be loaded to the neural network for defect detection to obtain detection results; the network loss can be determined by the difference between the sample images' detection results and their labels; the Step adjusts the parameters of the neural network according to the network loss.

In another embodiment, when the neural network processes a plurality of sample images at the same time, the sample images in the training set can be divided into multiple batches for processing according to processing capacity of the neural network, to improve its processing efficiency.

In another embodiment, when the neural network meets the preset training termination condition, this training can be ended to obtain the trained neural network. A trained neural network can be used for defect detection. The preset training termination condition can be set according to actual needs. For example, the termination condition can be that the neural network's output on the validation set meets expectations; or the termination condition can be that the network loss of the neural network is lower than a certain threshold or converge within a threshold range; other termination conditions are also possible. This disclosure does not limit the specific termination conditions.

In another embodiment, the actual application cannot collect all newly added sample images at once, so these images appear gradually over time. Therefore, when a newly added sample image appears in the library, the above neural network training method can be used to perform advanced training on the neural network. With the number of sample images in the library gradually increases, the neural network improves as it undergoes each round of advanced training.

In another embodiment, the aforementioned neural network training method based on memory scores can also be used for advanced training of neural networks in other applications (e.g., target detection, image recognition, or pose estimation). This disclosure does not limit the range of applications.

In another embodiment, Step S100 may comprise: for any first-sample image, determining its discounted score when the neural network undergoes the i^{th} training, based on the training indicator and the preset discount rate of the said first-sample image in the i^{th} training, where i is defined as the number of training sessions before the current one, with the i of the current training of the neural network is set to 0, i is an integer and 0≤i≤N, with N being the training age of the said first-sample image, an integer and N≥0; the sum of the N discounted scores of the said first-sample image is determined as the memory score of the said first-sample image.

In another embodiment, the i^{th} training of the neural network means the i^{th} training before the current one, such that the i for the current training is 0. For example, the 0th training of the neural network is the current one, the first training is the one immediately before the current one, and the second training is the one before the first training, and so on.

In another embodiment, when the first-sample image is added to the training set during the i^{th} training of the neural network, the training indicator of the first-sample image in the i^{th} training is set to 1; when the said first-sample image is not added to the training set during the i^{th} training of the neural network, the training indicator of the said first-sample image in the i^{th} training is set to 0.

In another embodiment, the discounted score of the said first-sample image in the i^{th} training of the neural network is determined based on the training indicator of the image during the i^{th} training and the preset discount rate. When the training age of a first-sample image is N, meaning that the neural network has been trained for N times, the method determines N discounted scores of the first-sample image. The sum of the N discounted scores of the first-sample image can be set as the memory score of the first-sample image.

In this embodiment, the discounted scores of the first-sample image in each round of the neural network's training can be determined according to the training indicators of the first-sample image in each round and the preset discount rate, and the sum of the discounted scores is determined as the memory score of the first-sample image, to improve the accuracy of the memory scores.

In an embodiment, the discounted score of the said first-sample image is determined based on the training indicator of the said first-sample image in the i^{th} training and the preset discount rate. This may comprise: setting the discounted score of the said first-sample image during the i^{th} training of the neural network, as the product of the training indicator during the i^{th} training and the preset discount rate raised to the i^{th} power.

In an embodiment, the memory score S of a first-sample image can be determined by the following equation (1):

S=Σᵢδ(i)βⁱ (1)

Wherein β represents the preset discount rate, δ(i) represents the training indicator of the first-sample image during the i^{th} training of the neural network, when the first-sample image is added to the training set during the i^{th} training of the neural network, δ(i)=1, when the first-sample image is not added to the training set of the i^{th} training, δ(i)=0.

For the 0th training (the current one), no first-sample image is added to the training set yet, so the training indicator of all first-sample images in the 0th training is set to 0, δ(0)=0.

In this embodiment, the discounted score of the said first-sample image during the i^{th} training of the neural network is set as the product of the training indicator during the i^{th} training and the preset discount rate raised to the i^{th} power, meaning that each training session produces a different discounted score, because the power of the discount rate falls as i increases. This process increases the accuracy of the discounted score.

In an embodiment, step S200 may comprise: from the said library, determining second-sample images, which are the first-sample images with the lowest memory scores, based on the memory scores of the said first-sample images and the preset first count; using the second-sample images to establish the first training set.

The Step may use sorting, comparing, and taking the minimum value to select first-sample images with the lowest memory scores, with the number of these images equals to the preset first count, and set the selected first-sample images as the second-sample images.

After a plurality of second-sample images are determined, the first training set can be established based on these second-sample images and their labels.

In this embodiment, a preset first count of second-sample images with the lowest memory scores are selected from the library, and a first training set is established based on the selected second sample images, so that the first training set includes both newly added sample images and the existing sample images with low memory scores. Training the neural network using the first training set allows the neural network to retain memories of the characteristics of the old defects when the network learns the characteristics of the new defects, thereby improving the accuracy of the neural network's defect detection.

FIG. 2 shows a flowchart of a neural network training method based on memory scores, according to an embodiment of the present disclosure. As shown in FIG. 2, the said method comprises: Step S400, which determines a plurality of third-sample images from the library according to the memory scores, training ages, and the preset second count, and uses these images to establish a second training set; Step S500, which trains the neural network based on the said second training set.

In another embodiment, after the memory scores of the first-sample images are determined by Step S100, Step S400 determines the third-sample images from the said library, based on the memory scores and the training ages of the first-sample images and the preset second count. There are many ways to select the third-sample images, either by using the memory scores and the training ages together, or by using the memory scores and the ages separately.

For example, the first step may pick first-sample images with a memory score less than 1 and a training age less than 10, and then take random samples from the selected first-sample images to choose a number of images equal to the second preset count, and set this sample of first-sample images as the plurality of third-sample images.

Or, the third-sample images may be chosen based on the memory scores and training ages. A certain number of third-sample images can be selected based on memory scores, then another number of third-sample images are selected based on training ages. The total of these two selections forms the second preset images.

It should be understood that there are many ways to determine third-sample images, which has a total number equal to the second preset count, based on the memory scores and training ages of the first-sample images in the library. Those skilled in the art can choose an appropriate method based on the actual need. The present disclosure does not limit the choices.

After the third-sample images are determined, a second training set can be established based on these third-sample images and their labels; then, in Step S500, the neural network is trained based on this second training set.

In this embodiment, the third-sample images are determined based on the memory scores and training ages of the first-sample images and the second preset count, and then used to establish the second training set. The second training set is then used to train the neural network. The third-sample images can be chosen based on both memory scores and training ages, producing a diversified set of images in the second training set. Training the neural network using the second training set improves the accuracy of the neural network's defect detection.

In another embodiment, step S400 may include: determining the fourth-sample images from the library by selecting the first-sample images with the lowest memory scores; determining fifth-sample images from the library by selecting the first-sample images with the smallest training ages, wherein the sum of the number of fourth-sample images and fifth-sample images equals to the preset second count; setting the third-sample images as the union of the said fourth-sample images and fifth-sample images; establishing the second training set based on the said third-sample images.

In another embodiment, the sum of the numbers of the fourth-sample images and fifth-sample images is the second preset count, which may be denoted as M; the number of fourth-sample images may be denoted as K; then the number of fifth-sample images is M-K. M and K are both positive integers and M>K. Those skilled in the art can set specific values of M and K according to actual needs, and the present disclosure does not limit this.

In another embodiment, K first-sample images with the lowest memory scores may be selected by sorting, comparing, and taking the minimum value, and the selected first-sample images can be set as the fourth-sample images.

In another embodiment, M-K first-sample images with the lowest memory scores may be selected by sorting, comparing, and taking the minimum value, and the selected first-sample images can be set as the fifth-sample images. The fifth-sample images and the fourth-sample images may have common elements.

The determined fourth-sample images and fifth-sample images can be set as third-sample images, and these third-sample images and their labels can be used to establish the second training set.

In another embodiment, when the second training set is being established, the fourth-sample images and fifth-sample images can be added alternately to the second training set.

In this embodiment, the second training set is established by using fourth-sample images, which are those with the lowest memory scores, and the fifth-sample images, which have the lowest ages. This method includes in the second training set both sample images with low degree of involvement in training, and sample images that have only been recently added to the library.

In another embodiment, before determining the memory scores of the plurality of first-sample images, the method further comprises: loading the labeled images into the neural network for defect detection to obtain the detection result of the said images, where the said labeled images are newly-added images that have not been added to the library; when the detection result of the labeled image is inconsistent with the preset expected result, modifying the label to obtain a modified label of the said image; adding the labeled images and the modified labels of the said images to the library.

In another embodiment, before adding the labeled images to the library, the labeled images can be loaded into the neural network for defect detection to obtain the detection result of the labeled images; then, check whether the detection result of the labeled images is consistent with the preset expected result. When the detection result is inconsistent, consider that the neural network cannot correctly identify the defect in the labeled images and therefore needs learning. The labels of the images will be changed according to the detection result, and the images and their modified labels are added to the library.

In another embodiment, the method further comprises: discarding the said labeled image when the detection result of the labeled image is consistent with the expected result. This means that when the detection result of the labeled image is consistent with the expected result, consider that the neural network can correctly identify the defect in the labeled image without learning, and the labeled image can be discarded, not added to the library.

In this embodiment, a newly-added labeled image can be loaded into the neural network for defect detection to obtain the detection result, and check whether the detection result is consistent with the expected result. When the detection result is consistent with the expected result, discard the labeled image; when the detection result is inconsistent with the expected result, the labeled image is added to the library. Discarding images will streamline the library, thereby reducing the size of the training set and time to converge of the neural network.

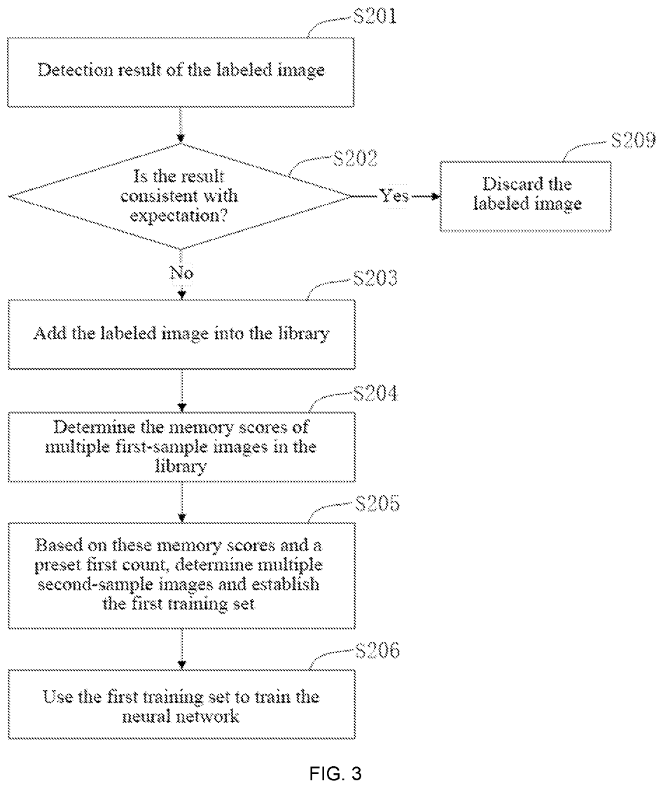

FIG. 3 shows a schematic diagram of an application scenario of a neural network training method based on memory scores, according to an embodiment of the present disclosure. As shown in FIG. 3, Step S201 loads a newly-added labeled image into the neural network for defect detection to obtain the detection result, and Step S202 checks whether the detection result is consistent with the expected result; when the detection result of the labeled image is consistent with the expected result, Step S209 is performed to discard the labeled image; otherwise, Step S203 is performed to modify the label of the image, and add it to the library to start advanced training of the neural network; Step S204 determines the memory scores of a plurality of first-sample images in the library, from their training ages, training indicators, and a preset discount rate; using these memory scores and a preset first count, Step 205 establishes a plurality of second-sample images, uses them to establish the first training set; using the first training set, Step 206 trains the neural network for defect detection. When the neural network meets the preset termination conditions, this advanced training ends.

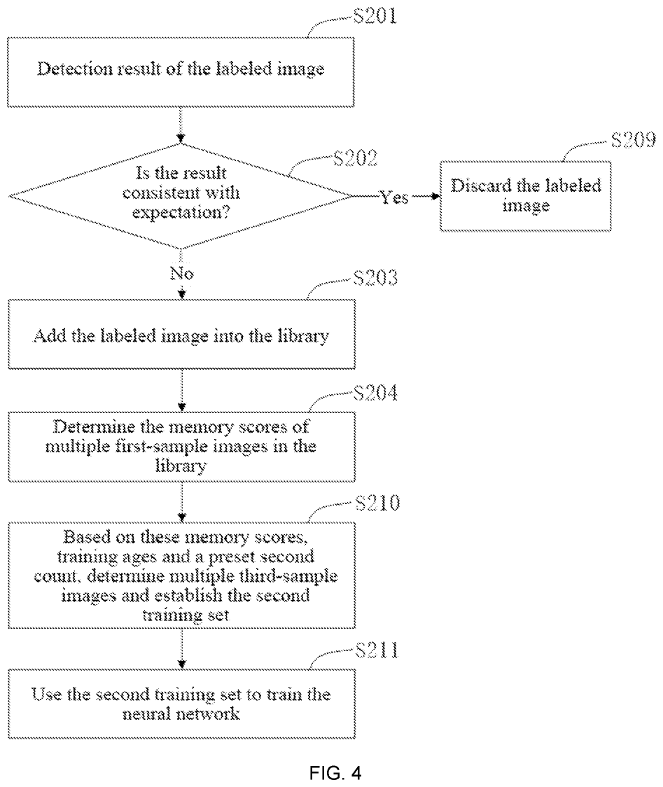

FIG. 4 shows a schematic diagram of an application scenario of a neural network training method based on memory scores, according to an embodiment of the present disclosure. As shown in FIG. 4, Step S201 loads the labeled image into the neural network for defect detection to obtain the detection result of the labeled image, and Step S202 checks whether the detection result of the labeled image is consistent with the expected result; when the detection result of the labeled image is consistent with the expected result, Step S209 is performed to discard the labeled image; otherwise, Step S203 is performed to modify the label of the image, and add it to the library to start advanced training of the neural network; Step S204 determines the memory scores of a plurality of first-sample images in the library, from their training ages, training indicators, and a preset discount rate; using these memory scores, training ages, and a preset second count, Step 210 determines a plurality of third-sample images and uses them to establish the second training set; and using the second training set, Step 211 trains the neural network for defect detection. When the neural network meets the preset termination conditions, this advanced training ends.

It should be noted that those skilled in the art should understand that the various methods and embodiments mentioned in this disclosure can be combined with each other to form a combined embodiment without violating the principles and logic. Due to the limit of space, this disclosure will not elaborate on this fact further.

According to an embodiment of the present disclosure, before a labeled image is added to the library, the image can be loaded into the neural network for defect detection to obtain the detection result. When the detection result is inconsistent with the expected result, the label of the image is modified and added to the library. This method reduces the size of the library, allows labelers to modify the labels based on the detection result, improves the labeler's understanding of defects and thereby improving the accuracy of the labels.

According to an embodiment of the present disclosure, when a new image is added to the library, advanced training of the neural network can be started. First, the method determines the memory scores of each sample image in the library, and then selects a certain number of sample images from the library to establish a training set, according to the images' memory scores alone, or according to both the memory scores and the training ages. This process will make the training set to include both newly added and existing sample images. Training the neural network using this training set allows the neural network to retain memories of the characteristics of the old defects as the network learns the characteristics of the new defects, thereby shortening the time to converge, improving the speed of the neural network's learning of new defects.

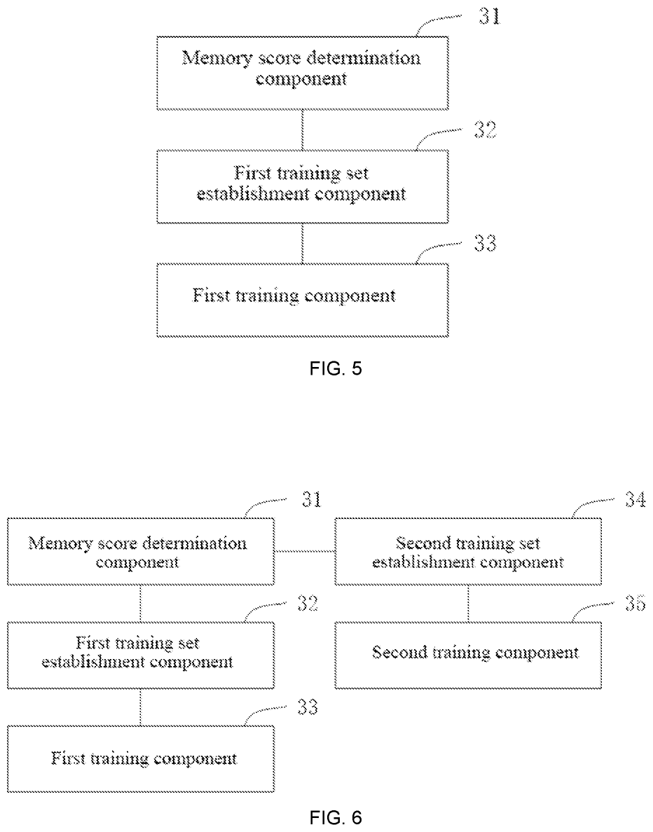

FIG. 5 shows a block diagram of a neural network training device based on memory scores, according to an embodiment of the present disclosure. As shown in FIG. 5, the device includes: a memory score determining component 31, which determines the memory scores of the first-sample images, according to the training ages and training indicators of the first-sample images and the preset discount rate, wherein the said plurality of first-sample images are images of the object to be inspected, the said first-sample images include at least one newly-added image, the training labels represent whether the first-sample images are added to the training set of each training session of the neural network, the training ages indicate the number of times the neural network is trained after the first-sample images are added to the library, and said the memory score indicates the degree of involvement in training of the first-sample images in training; a first training set establishment component 32, which determines a plurality of second-sample images from the said library to establish a first training set, based on the memory scores of the said first-sample images and the preset first count; a first training component 33, which trains the neural network by using the said first training set, wherein the said neural network is used for defect detection.

FIG. 6 shows a block diagram of a neural network training device based on memory scores, according to an embodiment of the present disclosure. As shown in FIG. 6, the device further comprises: a second training set establishment component 34, which determines a plurality of third-sample images from the said library according to the memory scores and training ages of the said first-sample images and the preset second count, and uses these images to establish a second training set; a second training component 35, which trains the neural network based on the said second training set,

In another embodiment, the said memory score determining component 31 comprises: a discounted score determination sub-component, which determines the discounted score of any first-sample image when the neural network undergoes the i^{th} training, based on the training indicator of the said first-sample image in the i^{th} training and the preset discount rate, where i is defined as the number of training sessions before the current one, with the i of the current training of the neural network is set to 0, i is an integer and 0≤i≤N, with N being the training age of the said first-sample image, an integer and N≥0; a memory score determination sub-component, which sets the sum of the N discounted scores of the first-sample image as the memory score of the said first-sample image.

In another embodiment, when the said first-sample images are added to the training set during the i^{th} training of the neural network, the training indicators of the said first-sample images in the i^{th} training are set to 1, when the said first-sample image is not added to the training set during the i^{th} training of the neural network, the training indicator of the said first-sample image in the i^{th} training is set to 0.

In another embodiment, the discounted score determination sub-component is configured as: setting the discounted score of the said first-sample image during the i^{th} training of the neural network, as the product of the training indicator during the i^{th} training and the preset discount rate raised to the i^{th} power.

In another embodiment, the first training set establishment component 32 comprises: a first-sample images determination sub-component, which determines a plurality of second-sample images with the lowest memory scores from the said library, according to the memory scores of the said first-sample images and the preset first count; a first training set establishment sub-component, which establishes the first training set based on the said second-sample images.

In another embodiment, the said second training set establishment component 34 comprises: a second-sample images determination sub-component, which determines the plurality of fourth-sample images by selecting the first-sample images with the lowest memory scores in the said library; a third-sample images determination sub-component, which determines fifth-sample images from the library by selecting the first-sample images with the smallest training ages, wherein the sum of the number of fourth-sample images and fifth-sample images equals to the preset second count; a fourth-sample images determination sub-component, which determines the set of third-sample images as the total of the said fourth-sample images and fifth-sample images; a second training set establishment sub-component, which establishes the second training set based on the said third-sample images.

In another embodiment, the device further includes: an image detection component, which loads the labeled images into the neural network for defect detection to obtain the detection result of the said images, where the said labeled images are newly-added images that have not been added to the library; an image labeling component, which is used to modifying the label to obtain a modified label of the said image, when the detection result of the labeled image is inconsistent with the preset expected result; an image adding component, which is used to add the labeled images and the modified labels of the said images to the library.

In another embodiment, the device further includes: an image discarding component, which discards the said labeled image when the detection result of the labeled image is consistent with the expected result.

According to another aspect of the present disclosure, there is provided a computer-readable storage medium with computer programs and instructions stored thereon, characterized in that when the computer program is executed by a processor, it implements the above-stated methods.

The above are only examples of embodiments of the present invention, and do not limit the scope of the patent protection of the present invention. Any equivalent transformation of structures and processes, made using the description and drawings of the present invention, or directly or indirectly applied to other related technical fields, are therefore also included in the scope of patent protection of the present invention.

What is claimed is:

1. A computer-implemented method for training a neural network based on memory scores, comprising:
determining, at a computing device having one or more processors, a memory score for each particular first-sample image of a plurality of first-sample images from a library based on a training age of the particular first-sample image, a training indicator of the particular first-sample image, and a preset discount rate, wherein the said first-sample images are images of an object to be inspected, the plurality of first-sample images including at least one newly-added image, the training indicator representing whether its corresponding first-sample image is added to a training set of each training session of the neural network, the training age indicating a number of times the neural network is trained after its corresponding first-sample image is added to the library, wherein the memory scores indicate a degree of involvement of the first-sample images in training;
determining, at the computing device, a plurality of second-sample images from the library, according to the memory scores of the first-sample images and a preset first count;
using, at the computing device, the plurality of second-sample images to establish a first training set; and
training, at the computing device, the neural network by using the first training set,
wherein the said neural network is used for defect detection.

2. The computer-implemented method of claim 1, further comprising:
determining, at the computing device, a plurality of third-sample images from the library according to the memory scores and training ages of the first-sample images and a preset second count;
using, at the computing device, the plurality of third-sample images to establish a second training set; and
using, at the computing device, the second training set to train the neural network.

3. The computer-implemented method of claim 1, wherein determining the memory scores of the plurality of first-sample images based on the training ages, the training indicators, and the preset discount rate comprises:
for each particular first-sample image, determining a discounted score when the neural network undergoes the i^{th} training, based on the preset discount rate and the training indicator of the particular first-sample image in the i^{th} training, where i is defined as the number of training sessions before the current one, with the i of the current training is set to 0, i is an integer and 0≤i≤N, N is an integer corresponding to the training age of the particular first-sample image, and N≥0;
a sum of the N discounted scores of the particular first-sample image is determined as the memory score of the particular first-sample image.

4. The computer-implemented method of claim 3, wherein, when the particular first-sample image is added to the training set during the i^{th} training of the neural network, the training indicator of the particular first-sample image in the i^{th} training is set to 1, and
when the particular first-sample image is not added to the training set during the i^{th} training of the neural network, the training indicator of the particular first-sample image in the i^{th} training is set to 0.

5. The computer-implemented method of claim 3, wherein determining the discounted scores of the first-sample images in the i^{th} training of the neural network based on the training indicators during the i^{th} training and the preset discount rate comprises:
setting the discounted score of each particular first-sample image during the i^{th} training of the neural network as the product of the training indicator during the i^{th} training and the preset discount rate raised to the i^{th} power.

6. The computer-implemented method of claim 1, wherein determining the plurality of second-sample images from the library and using the plurality of second-sample images to establish the first training set, based on the memory scores of the said first-sample images and the preset first count, comprises:
determining the second-sample images by selecting the first-sample images with the lowest memory scores from the library, according to the memory scores of the said first-sample images and the preset first count;
establishing the first training set based on the second-sample images.

7. The computer-implemented method of claim 1, further comprising:
determining, at the computing device, a plurality of third-sample images from the library based on the memory scores and training ages of the said first-sample images and a preset second count;
using, at the computing device, the plurality of third-sample image to establish a second training set;
determining, at the computing device, fourth-sample images from the library by selecting the first-sample images with the lowest memory scores;
determining, at the computing device, fifth-sample images from the library by selecting the first-sample images with the smallest training ages, wherein the sum of the number of fourth-sample images and fifth-sample images is equal to the preset second count;
setting, at the computing device, the third-sample images as the union of the fourth-sample images and fifth-sample images;
establishing, at the computing device, the second training set based on the third-sample images.

8. The computer-implemented method of claim 1, further comprising:
loading, at the computing device, labeled images into the neural network for defect detection to obtain a detection result of the labeled images, wherein the labeled images are newly-added images that have not been added to the library;
when the detection result of each particular labeled image is inconsistent with a preset expected result, modifying, at the computing device, a label of the particular labeled image to obtain a modified label of the particular labeled image;
adding, at the computing device, the labeled images and the modified labels of the labeled images to the library.

9. The method according to claim 8, further comprising:
when the detection result of the particular labeled image is consistent with the expected result, discarding, at the computing device, the particular labeled image.

10. A computing device for training a neural network based on memory scores, comprising:
one or more processors; and
a non-transitory computer-readable storage medium having a plurality of instructions stored thereon, which, when executed by the one or more processors, cause the one or more processors to perform operations comprising:
determining a memory score for each particular first-sample image of a plurality of first-sample images from a library based on a training age of the particular first-sample image, a training indicator of the particular first-sample image, and a preset discount rate, wherein the said first-sample images are images of an object to be inspected, the plurality of first-sample images including at least one newly-added image, the training indicator representing whether its corresponding first-sample image is added to a training set of each training session of the neural network, the training age indicating a number of times the neural network is trained after its corresponding first-sample image is added to the library, wherein the memory scores indicate a degree of involvement of the first-sample images in training;
determining a plurality of second-sample images from the library, according to the memory scores of the first-sample images and a preset first count;
using the plurality of second-sample images to establish a first training set; and
training the neural network by using the first training set,
wherein the said neural network is used for defect detection.

11. The computing device of claim 10, wherein the operations further comprise:
determining a plurality of third-sample images from the library according to the memory scores and training ages of the first-sample images and a preset second count;
using the plurality of third-sample images to establish a second training set; and
using the second training set to train the neural network.

12. The computing device of claim 10, wherein determining the memory scores of the plurality of first-sample images based on the training ages, the training indicators, and the preset discount rate comprises:
for each particular first-sample image, determining a discounted score when the neural network undergoes the i^{th} training, based on the preset discount rate and the training indicator of the particular first-sample image in the i^{th} training, where i is defined as the number of training sessions before the current one, with the i of the current training is set to 0, i is an integer and 0≤i≤N, N is an integer corresponding to the training age of the particular first-sample image, and N≥0;
a sum of the N discounted scores of the particular first-sample image is determined as the memory score of the particular first-sample image.

13. The computing device of claim 12, wherein, when the particular first-sample image is added to the training set during the i^{th} training of the neural network, the training indicator of the particular first-sample image in the i^{th} training is set to 1, and
when the particular first-sample image is not added to the training set during the i^{th} training of the neural network, the training indicator of the particular first-sample image in the i^{th} training is set to 0.

14. The computing device of claim 12, wherein determining the discounted scores of the first-sample images in the i^{th} training of the neural network based on the training indicators during the i^{th} training and the preset discount rate comprises:
setting the discounted score of each particular first-sample image during the i^{th} training of the neural network as the product of the training indicator during the i^{th} training and the preset discount rate raised to the i^{th} power.

15. The computing device of claim 10, wherein determining the plurality of second-sample images from the library and using the plurality of second-sample images to establish the first training set, based on the memory scores of the said first-sample images and the preset first count, comprises:
determining the second-sample images by selecting the first-sample images with the lowest memory scores from the library, according to the memory scores of the said first-sample images and the preset first count;
establishing the first training set based on the second-sample images.

16. The computing device of claim 10, wherein the operations further comprise:
determining a plurality of third-sample images from the library based on the memory scores and training ages of the said first-sample images and a preset second count;
using the plurality of third-sample image to establish a second training set;
determining fourth-sample images from the library by selecting the first-sample images with the lowest memory scores;
determining fifth-sample images from the library by selecting the first-sample images with the smallest training ages, wherein the sum of the number of fourth-sample images and fifth-sample images is equal to the preset second count;
setting the third-sample images as the union of the fourth-sample images and fifth-sample images;
establishing the second training set based on the third-sample images.

17. The computing device of claim 10, wherein the operations further comprise:
loading labeled images into the neural network for defect detection to obtain a detection result of the labeled images, wherein the labeled images are newly-added images that have not been added to the library;
when the detection result of each particular labeled image is inconsistent with a preset expected result, modifying a label of the particular labeled image to obtain a modified label of the particular labeled image;
adding the labeled images and the modified labels of the labeled images to the library.

18. The computing device of claim 17, wherein the operations further comprise:
when the detection result of the particular labeled image is consistent with the expected result, discarding the particular labeled image.

19. A non-transitory computer-readable storage medium having a plurality of instructions stored thereon, which, when executed by one or more processors, cause the one or more processors to perform operations comprising:
determining a memory score for each particular first-sample image of a plurality of first-sample images from a library based on a training age of the particular first-sample image, a training indicator of the particular first-sample image, and a preset discount rate, wherein the said first-sample images are images of an object to be inspected, the plurality of first-sample images including at least one newly-added image, the training indicator representing whether its corresponding first-sample image is added to a training set of each training session of the neural network, the training age indicating a number of times the neural network is trained after its corresponding first-sample image is added to the library, wherein the memory scores indicate a degree of involvement of the first-sample images in training;
determining a plurality of second-sample images from the library, according to the memory scores of the first-sample images and a preset first count;
using the plurality of second-sample images to establish a first training set; and
training the neural network by using the first training set,
wherein the said neural network is used for defect detection.

20. The non-transitory computer-readable storage medium of claim 19, wherein the operations further comprise:
determining a plurality of third-sample images from the library according to the memory scores and training ages of the first-sample images and a preset second count;
using the plurality of third-sample images to establish a second training set; and
using the second training set to train the neural network.
